(19) United States
(12) Patent Application Publication
(10) Pub. No.: US 2012/0090874 A1
(43) Pub. Date: Apr. 19, 2012

(54) HIGH PERFORMANCE, HIGH TEMPERATURE LIGHTWEIGHT FILM, TAPE OR SHEATH FOR WIRE INSULATION

(75) Inventors: Antonio Pagliuca, Oxfordshire (GB); Philip Hammond, Wiltshire (GB)

(73) Assignee: Tyco Electronics UK LTD, Wiltshire (GB)

(21) Appl. No.: 13/380,399

(22) PCT Filed: Jun. 16, 2010
(86) PCT No.: PCT/GB2010/051000

§ 371 Date: Dec. 22, 2011

(30) Foreign Application Priority Data
Jun. 26, 2009 (GB) 0911047.9
Aug. 5, 2009 (GB) 0913634.2

(51) Int. Cl. H01B 3/30; B32B 27/08; H01B 13/08

(52) U.S. Cl. 174/120 SR; 156/56; 428/422

(57) ABSTRACT

A thin, lightweight insulated wire comprises a core (10) with an insulating polymeric sheath comprising an inner layer (12) of polytetrafluroethylene (PTFE) to empower electrical insulation, a middle layer (14) of an aromatic and/or heterocyclic ring-containing polymer such as polyetheretherketone(PEEK) to provide enhanced mechanical properties such as abrasion and cut-through resistance and an outer layer (16) of PTFE which provides electrical and chemical resistance and allows the whole construction to be sintered. The middle layer may undergo some flow and alloying during sintering, which may provide additional and unexpected benefits. The preferred thickness of each film is 25 to 50 μm. The use of such thin films allows for a compact, thin and lightweight insulation to be produced.

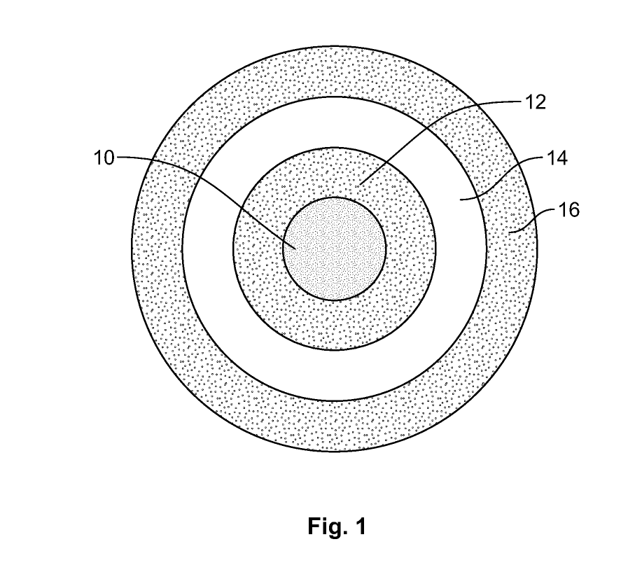

This invention relates to lightweight, high performance, high temperature and fire resistant films or tapes, in particular for use as insulation for wires and cables to be used in a wide variety of environments, including demanding conditions such as in drilling or mining, commercial or military aerospace and marine applications and automotive, rail and mass transport. Such cables may be exposed to high or low temperatures as well as to corrosive substances or atmospheres or to fire. High performance wires generally comprise a functional core such as an electrical conductor or optical fibre, and one or more insulating and/or protective coatings. These coatings should be flexible and not too bulky, since wires are required in many cases to be of light weight and small diameter.

Various types of polymer are known for use in wire and cable sheaths, such as polytetrafluoroethylene (PTFE) and polyetheretherketone (PEEK). PTFE has the advantage of being very tough as well as chemically inert, with a high softening point, low coefficient of friction and good electrical insulating properties.

PEEK has found increasing use in wire and cable sheathing since it has good flame resistance, being self extinguishing with very low smoke. It also has good elongation, good flexibility in thin sections such as films and good mechanical resistance to dynamic cut-through and scrape abrasion. It can however be susceptible to arc tracking and also to attack by acetone and strong acids.

EP-A-572177 discloses an electrical insulation laminate of porous PTFE and PEEK. The purpose of this is to provide a flexible electrical insulation material for air frame wire insulation which is lightweight with high mechanical strength, thermal resistance and chemical resistance and reduced dielectric constant.

There remains however a demand for wire and cables that are thin and lightweight, with insulations that are resistant to fire as well as to high temperatures and other hostile conditions. One way of imparting such flame resistance is to apply a coating comprising mica particles, typically platelets, dispersed in a polymer matrix. JP-A-2003100149 for example discloses the use of a dispersion of fine mica power and glass frit in a silicone resin for coating fire resistant cables. Mica can however add to the cost and accordingly there is a need to reduce or avoid mica content.

Our copending patent application GB 0810294.9, filed on 5^{th} Jun. 2008, discloses and claims a wire or cable comprising a core and a polymeric sheath, including a wrapped film of PEEK, or a polymer blend or alloy of PEEK containing at least 30% by weight of PEEK and another polymer, having a thickness of 5 to 150 μm. The PEEK layer may be combined with a fire resistant layer of a polymer matrix in which mica particles are disposed, and may also have a protective outer layer, for example a fluoropolymer such as PTFE.

The present invention provides a sheath for a high performance, high temperature wire comprising an inner layer of PTFE, a middle layer of a polymeric film containing aromatic and/or heterocyclic rings and a sintered outer layer of PTFE, the thickness of each layer being in the range of 12 to 100 μm.

The insulation may comprise a laminated tape to be wound around a wire, or may be extruded directly onto the wire, at least the outer layer of PTFE being sintered in situ. The insulation layers are preferably wrapped spirally around the core, preferably with an overlap of 25 to 65%, more preferably 40 to 55%. The layers may be applied individually or using a laminate of two or three of the layers. The preferred overlap angle is 45° to 55°.

The middle layer may for example contain a polyaryl ether ketone (PAEK) or a polymer comprising nitrogen, sulphur and/or oxygen-containing heterocyclic rings. Preferred heterocyclic polymers include those comprising a six-membered ring fused with a five-membered ring, such as polybenzimidazole, polybenzoxazole and polybenzothiazole, and blends or alloys of these compounds.

The preferred PAEK is polyetherether ketone (PEEK), but other PAEKs can be used, alone or in blends or alloys for example polyether ketones (PEK), polyether ketone ether ketone ketones (PEKEKK) and polyether ketone ketones (PEKK).

The sintering of the outer PTFE layer fusion-bonds the whole composite together in a sealed construction, providing superior chemical resistance in addition to the excellent mechanical properties imparted by the PAEK layer. Sintering preferably takes place at a temperature in the range from 350 to 420° C. All three insulation layers may be sintered. PEEK typically melts at around 343° C. Sintering causes the PTFE to shrink, thereby providing a highly compact sheath of insulating material. The residence time for sintering is preferably 30 seconds to 2 minutes, more preferably 60 to 90 seconds.

According to a further aspect of the invention, there is provided a three-layer composite insulating film or tape construction comprising a first layer of polytetrafluoroethylene (PTFE), an intermediate second layer of a polymer containing aromatic and/or heterocyclic rings, and a third layer of PTFE.

The preferred thickness for each of the layers is 25 to 75 μm. By means of the invention therefore there can be made a very thin, very lightweight wire of relatively inexpensive materials that nonetheless has excellent mechanical properties as well as being resistant to high temperature and chemical attack.

The accompanying drawing is an enlarged cross sectional view of an insulated wire having a 3-layer sheath in accordance with the invention. The insulated wire comprises a core conductor 10 which may be a single or multifilament conductive metallic core, for example of copper, aluminium, silver or steel. For other purposes, the core could instead be a polymeric, carbon fibre or ceramic core.

Around the core is an inner layer 12 of PTFE, preferably having a thickness of 25 to 75 μm.

This helps to provide the electrical insulation in the case of a conductive metallic core. Being very tough and with a low coefficient of friction, the inner layer can be relied on to protect the core even when the wire is subjected to stresses which might damage insulating layers of other materials. The electrical protection imparted by this layer includes resistance to dry/wet arc tracking.

Around the inner PTFE layer is an intermediate layer 14 of an aryl or heterocyclic ring-containing polymer such as a polyaryl ether ketone, preferably polyetherether ketone (PEEK). This has a thickness in the range from 12 to 100 μm, preferably 25 to 75 μm. This layer provides excellent mechanical properties such as resistance to scrape and dynamic cut-through. Around the PEEK layer is a final outer layer 16 of sintered PTFE. This provides both electrical and chemical resistance. Having a PTFE outer layer allows the whole construction to be sintered. The PEEK layer may undergo flow and alloying during sintering, which may enhance the properties of all three layers.

Applying thin films to make up an insulated wire according to the invention allows for a compact, thin and lightweight insulation to be produced.

The wire illustrated can be produced by wrapping individual layers, wrapping a laminated composite film of two or three layers or by extrusion of the three protective layers, followed by sintering. The sintering gives rise to an unexpected synergistic enhancement of the properties of the individual layers.

The following example illustrates the manufacture of a high performance, high temperature lightweight wire in accordance with the present invention.

Three successive layers were spirally wound from tape onto a nickel coated copper wire comprising 22 awg copper. First, an inner layer of PTFE was wound from a Lenzing LD-PTFE tape having a width of 4.0 mm and a thickness of 48 μm was spirally wound with an overlap angle of 45° to 55°.

To form an intermediate layer, a PEEK tape (APTIV 1,000) tape having a width of 6.0 mm and a thickness of 45 μm was wound in the opposite direction to the inner layer, again at an overlap angle of 45 to 55.

Finally an outer layer was wound over the intermediate layer from a 3P 500 grade PTFE tape having a width of 6.5 mm and thickness of 50 μm, in the same winding direction as the inner layer and again with an overlap angle of 45° to 55°.

The three layer composite thus formed was then sintered at a temperature at 400° C. with a residence time of 60 to 90 seconds, to form a lightweight, high performance, high temperature.

1. A wire or cable comprising a core and an insulating polymeric sheath, wherein said sheath includes an inner layer of polytetrafluoroethylene (PTFE) having a thickness of 12 to 100 μm, an intermediate layer around the inner layer comprising a polymer containing aromatic and/or heterocyclic rings, having a thickness of 12 to 100 μm and a sintered outer layer of PTFE having a thickness of 12 to 100 μm.

2. A wire or cable according to claim 1 wherein the intermediate layer comprises a polyaryl ether ketone (PAEK) or a blend or alloy thereof.

3. A wire or cable according to claim 2 wherein the PAEK intermediate layer comprises polyether ether ketone (PEEK) or a blend or alloy thereof.

4. A wire or cable according to claim 1 wherein the intermediate layer comprises a polymer of heterocyclic units containing a six-membered ring fused with a five-membered ring.

5. A wire or cable according to claim 4 wherein the intermediate layer comprises units of polybenzimidazole, polybenzoxazole and/or polybenzothiazole.

6. A wire or cable according to claim 1 wherein the intermediate layer film has a thickness of 25 to 75 μm.

7. A wire or cable according to claim 6 wherein each of the three layers around the core has a thickness of 25 to 75 μm.

8. A wire or cable according to claim 1 wherein the intermediate and/or inner layers of the sheath are sintered.

9. A wire or cable according to claim 1 wherein the core is a conductive metallic core.

10. A wire or cable according to claim 9 wherein the core is of copper, aluminium, silver or steel.

11. A wire or cable according to claim 1 wherein the core is a polymeric, carbon fibre or ceramic core.

12. A wire or cable according to claim 1 wherein each of said layers is an individually wrapped layer.

13. A wire or cable according to claim 1 wherein two or three of said insulating layers are applied in the form of a laminated composite film.

14. A wire or cable according to claim 12 wherein said insulating layers and/or laminated composite film are spirally wound onto the core with an overlap of 25 to 60%.

15. A wire or cable according to claim 1 wherein the insulating layers are formed by extrusion.

16. A method of making an insulated wire or cable which comprises the steps of spirally winding onto an elongate core an inner layer of polytetrafluoroethylene (PTFE) having a thickness of 12 to 100 μm, an intermediate layer of polyetherether ketone (PEEK) having a thickness of 12 to 100 μm and an outer layer of PTFE having a thickness of 12 to 100 μm, and sintering at least said outer layer.

17. A method according to claim 16 wherein said sintering takes place at a temperature in a range from 350 to 420° C.

18. A composite insulating film or tape construction comprising a first layer of polytetrafluoroethylene (PTFE), an intermediate second layer of a polymer containing aromatic and/or hererocyclic rings and a third layer of PTFE.
